(19) United States
(12) Patent Application Publication
(10) Pub. No.: US 2009/0293822 A1
(43) Pub. Date: Dec. 3, 2009

(54) GENERAL-PURPOSE V-TYPE ENGINE

(75) Inventors: Hayato Matsuda, Wako-shi (JP); Teruyuki Saitoh, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 12/470,618

(22) Filed: May 22, 2009

(30) Foreign Application Priority Data
May 28, 2008 (JP) 2008-140107
May 28, 2008 (JP) 2008-140108

(51) Int. Cl. F02B 75/22

(52) U.S. Cl. 123/54.4

(57) ABSTRACT

To a first bank B1 and a second bank B2, a first throttle body T1 and a second throttle body T2 placed between the banks B1, B2 are attached, respectively, in such a manner that an axis A3 of an intake path 8 of each of the first throttle body T1 and the second throttle body T2 is substantially perpendicular to an axis A2 of a corresponding one of the banks B1, B2. Each of the throttle bodies T1, T2 has a throttle valve 9 pivotally supported therein and the fuel injection valve 10 injecting fuel to the intake path 8 at a part downstream of the throttle valve 9. The throttle valve 9 of each of the first and second throttle bodies T1, T2 is placed in such a manner that an axis A4 of a valve shaft 9a of the throttle valve 9 is substantially orthogonal to the axis A3 of the corresponding intake path 8 and is substantially parallel to the axis A2 of a corresponding one of the banks B1, B2. Accordingly, it can easily prevent a large amount of condensation from being generated and freezing around the valve shaft of a throttle valve even in a cold weather.

### BACKGROUND OF THE INVENTION

1. Field of the Invention

The present invention relates to an improvement of a general-purpose V-type engine in which a first bank and a second bank are provided continuously to a crankcase supporting a crankshaft, the first and second banks being arranged in a V-shape with its center being a plane including an axis of the crankshaft, and an engine installation face is formed on the crankcase, the engine installation face being either substantially perpendicular to the plane and substantially horizontal, or substantially perpendicular to the axis of the crankshaft and substantially horizontal.

2. Description of the Related Art

Such a general-purpose V-type engine is known from Patent Publication 1, for example.

After use, the general-purpose V-type engine is often left outdoors at night for a long time. Accordingly, in a cold weather, a large amount of condensation is generated and freezes around the valve shaft of a throttle valve. This causes the throttle valve to fixate, making it sometimes difficult to use the engine immediately.

[Patent Publication 1] Patent Application Laid-open No. 2000-120651

### SUMMARY OF THE INVENTION

The present invention has been made in consideration of such circumstances, and has a first objective of providing a general-purpose V-type engine that can easily prevent a large amount of condensation from being generated and freezing around the valve shaft of a throttle valve in a cold weather. The present invention also has a second objective of preventing fuel from remaining in the fuel injection nozzle of a fuel injection valve in a general-purpose V-type engine in which throttle bodies each having the fuel injection valve are respectively fitted to first and second banks, by causing the fuel injection nozzle to always face downward regardless of whether the engine is used as a horizontal-type or a vertical-type.

In order to achieve the above first object, according to a first feature of the present invention, there is provided a general-purpose V-type engine in which a first bank and a second bank are provided continuously to a crankcase supporting a crankshaft, the first and second banks being arranged in a V-shape with its center being a plane including an axis of the crankshaft, and an engine installation face is formed on the crankcase, the engine installation face being either substantially perpendicular to the plane and substantially horizontal, or substantially perpendicular to the axis of the crankshaft and substantially horizontal, characterized in that a first throttle body and a second throttle body placed between both the banks are mounted to the first bank and the second bank, respectively, in such a manner that an axis of an intake path of each of the first throttle body and the second throttle body is substantially perpendicular to a plane including an axis of a corresponding one of the banks and the axis of the crankshaft, each of the throttle bodies has a butterfly-type throttle valve pivotally supported therein and a fuel injection valve attached thereto, the butterfly-type throttle valve opening and closing the corresponding intake path, the fuel injection valve injecting fuel to the intake path at a portion downstream of the throttle valve, and the throttle valve of each of the first and second throttle bodies is placed in such a manner that an axis of a valve shaft of the throttle valve is substantially orthogonal to the axis of the corresponding intake path and is substantially parallel to the axis of a corresponding one of the banks. Here, the engine installation face corresponds to an engine installation flange 30 of an embodiment of the present invention, which will be described below.

According to the first feature of the present invention, when the engine is used as a horizontal-type, the valve shaft of the throttle valve of each of the first and second throttle bodies inclines to the horizontal plane. This inclination allows most of the condensation water drops generated on the outer peripheral surface of the valve shaft to flow downward along the valve shaft to the inclined bottom face of the intake path, and then to flow further downward along the bottom face. The condensation water drops can thus be discharged from the valve shaft. As a result, it can be prevented that large water drops remain on the valve shaft, which in turn prevents fixation of the valve shaft of the throttle valve caused by freezing of the large water drops. And when the engine is used as a vertical-type where the crankshaft is perpendicular to the horizontal engine installation flange, the intake path and the valve shaft of each of the first and second throttle bodies are substantially horizontal. This allows most of the condensation water drops generated around opposite end parts of the valve shaft in the intake path to flow toward the bottom face of the intake path and to be discharged from the valve shaft. As a result, also in this case, it can be prevented that large water drops remain on the valve shaft, which in turn prevents fixation of the valve shaft of the throttle valve caused by freezing of the large water drops. In this way, regardless of whether the engine is used as the horizontal-type or the vertical-type, the throttle valves can be easily prevented from fixation which would be caused by freezing of condensation, without changing the first and second throttle bodies. Consequently, the throttle valves can always be driven to open and close appropriately by the operation of the electric motor, allowing the engine to operate immediately.

In addition, the first and second throttle bodies are placed in a valley part between the first and second banks. This valley part allows effective use for the placement of two throttle bodies and also allows size reduction of the V-type engine. Moreover, the length of the intake path from each of the throttle bodies to the corresponding bank can be reduced to a minimum, which accomplishes improved acceleration responsiveness of the engine.

Further, according to a second feature of the present invention, in addition to the first feature, the first and second throttle bodies are compatible with each other, and the fuel injection valve of the first throttle body and the fuel injection valve of the second throttle body are placed to face in a direction toward a same outer surface of the engine.

According to the second feature of the present invention, throttle bodies with the same structure can be used as the first and second throttle bodies. This contributes to improvement of the productivity and reduction in costs. Here, the first and second throttle bodies are placed in such a manner that their respective fuel injection valves are placed to face in a direction toward the same outer surface of the engine. This allows the fuel injection valves of the two throttle bodies to be attached/detached or to be inspected and maintained from the same outer surface side of the engine, thereby yielding easy maintenance.

In order to achieve the above second object, according to a third feature of the present invention, there is provided a general-purpose V-type engine in which a first bank and a second bank are provided continuously to a crankcase supporting a crankshaft, the first and second banks being arranged in a V-shape with its center being a vertical plane including an axis of the crankshaft, and an engine installation face is formed on the crankcase, the engine installation face being either substantially perpendicular to the vertical plane and substantially horizontal, or substantially perpendicular to the axis of the crankshaft and substantially horizontal, characterized in that a first throttle body and a second throttle body placed between both the banks are mounted to the first bank and the second bank, respectively, in such a manner that an axis of an intake path of each of the first throttle body and the second throttle body is substantially perpendicular to a plane including an axis of a corresponding one of the banks and the axis of the crankshaft, each of the throttle bodies has a throttle valve provided therein and a fuel injection valve attached thereto, the throttle valve opening and closing the corresponding intake path, the fuel injection valve injecting fuel toward the intake path at a portion downstream of the throttle valve, and each the fuel injection valve is placed in such a manner that a fuel injection nozzle of the fuel injection valve faces obliquely downward with an axis of the fuel injection valve being on a plane which includes the axis of the corresponding intake path and is substantially orthogonal to the axis of a corresponding one of the banks. Here, the engine installation face corresponds to an engine installation flange 30 of an embodiment of the present invention, which will be described below.

According to the third feature of the present invention, the fuel injection valve of each of the first and second throttle bodies is placed in such a manner that the fuel injection nozzle is positioned obliquely downward with the axis of the fuel injection valve being on the plane including the axis of the corresponding intake path of the throttle body and substantially orthogonal to the axis of the corresponding bank. Accordingly, regardless of whether the engine E used as a horizontal-type or a vertical-type, each of the fuel injection valves can always maintain its posture in which the fuel injection nozzle faces obliquely downward. Accordingly, after the engine stops its operation, fuel remaining in the fuel injection nozzle of each of the fuel injection valves slides down promptly. Since the fuel does not keep remaining in the fuel injection nozzles, residual product is prevented from being generated due to deterioration of remaining fuel, and operation failure of the fuel injection valves 10 due to the residual product can be avoided.

In addition, the first and second throttle bodies are placed in a valley part between the first and second banks. This valley part allows effective use for the placement of the two throttle bodies and also allows size reduction of the V-type engine. Moreover, the length of the intake path from each of the throttle bodies to the corresponding bank can be reduced to a minimum, which accomplishes improved acceleration responsiveness of the engine.

Further, according to a fourth feature of the present invention, in addition to the third feature, the first and second throttle bodies are compatible with each other, and the fuel injection valve of the first throttle body and the fuel injection valve of the second throttle body are placed to face in a direction toward a same outer surface of the engine.

According to the fourth feature of the present invention, throttle bodies with the same structure can be used as the first and second throttle bodies. This contributes to improvement of the productivity and reduction in costs. Here, the first and second throttle bodies are placed in such a manner that their respective fuel injection valves are placed to face in a direction toward the same outer surface of the engine. This allows the fuel injection valves of the two throttle bodies to be attached/detached or to be inspected and maintained from the same outer surface side of the engine, thereby yielding easy maintenance.

The above description, other objects, characteristics and advantages of the present invention will be clear from detailed descriptions which will be provided for the preferred embodiment referring to the attached drawings.

### BRIEF DESCRIPTION OF THE DRAWINGS

FIG. 1 is a front view of a general-purpose V-type engine of the present invention used as a horizontal-type with an essential part being cut out;

FIG. 2 is a view seen from an arrow 2 in FIG. 1; and

FIG. 3 is a plan view of a general-purpose V-type engine of the present invention used as a vertical-type with an essential part being cut out.

### DESCRIPTION OF THE PREFERRED EMBODIMENT

A preferred embodiment of the present invention will be explained below with reference to the attached drawings.

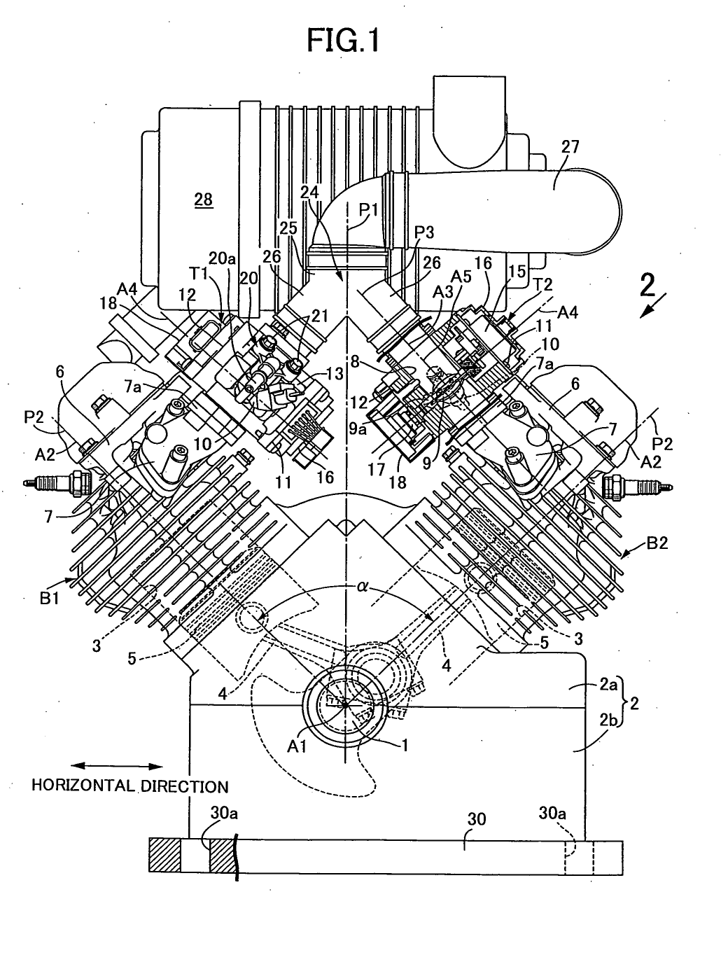

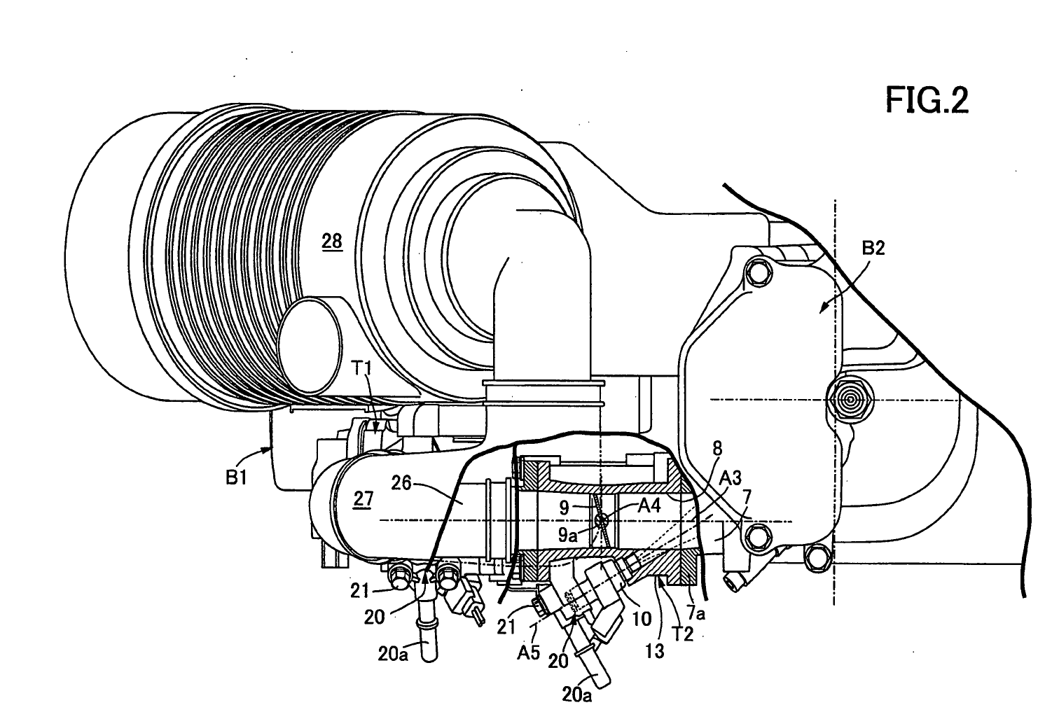

In FIGS. 1 and 2, a description will be given of an example in which the present invention is implemented to a general-purpose V-type two-cylinder engine E. The V-type engine E is formed of a crankcase 2 supporting a crankshaft 1, and first and second banks B1 and B2. The first and second banks B1 and B2 are continuously provided to the crankcase 2 at an upper part, and are disposed to be open in a V-shape having its center on a vertical plane P1 including an axis A1 of the crankshaft 1. The vertical plane P1 includes a line bisecting an included angle a (90° in the illustrated example) between second axes A2 and A2 of the respective first and second banks B1 and B2.

The first and second banks B1 and B2 each include a single cylinder 3. A piston 5 connected to the crankshaft 1 via a connecting rod 4 is fitted into the cylinder 3. Elbow-shaped intake pipes 7 are joined by bolts to cylinder heads 6 of the respective first and second banks B1 and B2, at respective corner parts on the front side (the paper surface side in FIG. 1) which are opposite to each other. Each of the intake pipes 7 is linked with an intake port of the corresponding first or second bank B1 or B2. An attachment flange 7a is formed to an upstream end of each of the intake pipes 7 in such a manner as to extend in parallel to an axis A2 of the corresponding bank B1 or B2. First and second throttle bodies T1 and T2 are placed between the first and second banks B1 and B2, and are joined by bolts to the respective attachment flanges 7a.

Here, each of the first and second throttle bodies T1 and T2 is placed in such a manner that an axis A3 of an intake path 8 linked with the corresponding intake pipe 7 is substantially perpendicular to a plane P2 including the axis A1 of the crankshaft 1 and the axis A2 of the corresponding bank B1 or B2.

Each of the first and second throttle bodies T1 and T2 has a throttle valve 9 for opening and closing its intake path 8, and an electromagnetic fuel injection valve 10 for injecting fuel to the intake path 8 at the side downstream of the throttle valve 9. The throttle valve 9 is of a butterfly-type, and its valve shaft 9a is rotatably supported by the corresponding throttle body T1 or T2.

Here, the valve shaft 9a is placed in such a manner that its axis A4 is orthogonal to the axis A3 of the corresponding intake path 8 and is parallel to the axis A2 of the corresponding bank B1 or B2.

Attached to a first side face 11 orthogonal to the valve shaft 9a of each of the first and second throttle bodies T1 and T2 are an electric motor 15 and a motor housing 16 housing the electric motor 15. An output part of the electric motor 15 is connected to an end of the valve shaft 9a so as to drive the throttle valve 9 to open and close. Attached to a second side face 12 opposite to the first side face 11 are a throttle sensor 17 and a sensor housing 18 housing the throttle sensor 17. The throttle sensor 17 detects an opening degree of the throttle valve 9.

Further, to a third side face 13, which forms a right angle with the first and second side faces 11 and 12, of each of the first and second throttle bodies T1 and T2, the fuel injection valve 10 is attached by an injection valve holder 20. The injection valve holder 20 is fixed to the third side face 13 by a pair of fastening bolts 21.

Here, the fuel injection valve 10 is placed in such a manner that its fuel injection nozzle is positioned obliquely downward with an axis A5 of the fuel injection valve 10 being on a plane P3 which includes the axis A3 of the corresponding intake path 8 and is substantially orthogonal to the axis A2 of the corresponding bank B1 or B2.

A fuel joint 20 is formed integrally with the injection valve holder 20 and is linked with a fuel inlet of the fuel injection valve 10. A fuel duct (not shown) is connected to the fuel joint 20 so as to induct fuel that is fed under pressure from a fuel pump.

The first and second throttle bodies T1 and T2 have the same structure so as to be compatible with each other. The first and second throttle bodies T1 and T2 are placed in such a manner that their respective fuel injection valves 10 are placed to face in a direction toward the same outer surface of the engine E. In the illustrated example, the fuel injection valves 10 are placed to face in a direction toward the front side (the paper surface side in FIG. 1). As a result, in the first and second throttle bodies T1 and T2, a position of the first side face 11 fitted with the electric motor 15 is opposite to a position of the second side face 12 fitted with the throttle sensor 17.

An intake manifold 24 is connected to upstream end parts of the intake paths 8 of the respective first and second throttle bodies T1 and T2. The intake manifold 24 is formed of a main pipe 25 and paired branch pipes 26 and 26 branched from the main pipe 25 in a V-shape. The paired branch pipes 26 and 26 are connected, by fitting, to the respective first and second throttle bodies T1 and T2 at their upstream end parts. An air cleaner 28 located directly above the engine E is connected to the main pipe 25 through an air duct 27.

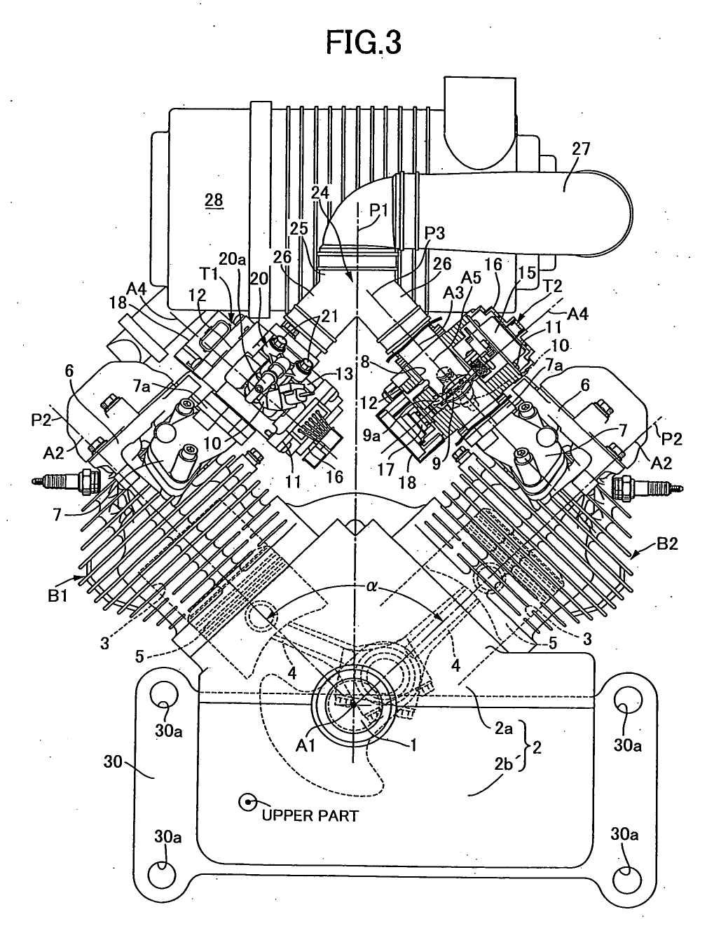

As shown in FIGS. 1 and 3, the crankcase 2 is formed of a first case semi-body 2a integrally coupled to the corresponding first or second bank B1 or B2, and a second case semi-body joined by a bolt to the first case semi-body 2a. An engine installation flange 30 is formed to the second case semi-body so as to allow the engine E to be installed in various work machines. As shown in FIGS. 1 and 2, two types of the second case semi-body, namely, second case semi-bodies 2b and 2b′ are prepared. The second case semi-bodies 2b and 2b′ have their engine installation flanges 30 at different positions.

In the second case semi-body 2b of the first type (see FIG. 1), the engine installation flange 30 is formed in the following manner. Specifically, the engine installation flange 30 is substantially horizontal and is substantially perpendicular to the vertical plane P1 that includes the axis A1 of the crankshaft 1 and the line bisecting the included angle α between the second axes A2 and A2 of the respective first and second banks B1 and B2. Accordingly, when the second case semi-body 2b of the first type is incorporated, the engine E serves as a horizontal-type engine that operates with the crankshaft 1 in a substantially-horizontal posture.

In the second case semi-body 2b′ of the second type (see FIG. 3), the engine installation flange 30 is formed in the following manner. Specifically, the engine installation flange 30 is substantially orthogonal to the axis A1 of the crankshaft 1 and is substantially horizontal. Accordingly, when the second case semi-body 2b′ of the second type is incorporated, the engine E serves as a vertical-type engine that operates with the crankshaft 1 in a substantially-vertical posture. Bolt holes 30a are provided to the engine installation flange 30 at its peripheral part so as to allow installation of the engine installation flange 30.

Next, operations of this embodiment will be explained.

While the work machine is being operated by operation of the engine E, air filtered by the air cleaner 28 is split by the intake manifold 24 to flow into the intake paths 8 of the respective first and second throttle bodies T1 and T2. The air flows through each intake path 8 while being mixed with fuel injected by the corresponding fuel injection valve 10, and then is taken into the cylinder 3 of the corresponding first or second cylinder bank B1 or B2. At this time, an unillustrated electric control unit controls the opening degree of the throttle valve 9 by operating the electric motor 15 of each of the first and second throttle bodies T1 and T2 so as to maintain the number of engine rotations which has been inputted and set in advance. The electric control unit also controls the amount of fuel injected from the fuel injection valve 10. The opening degree of the throttle valve 9 is detected by the throttle sensor 17 and fed back to the electric control unit.

Now, when the engine E after operation is left outdoors, for example, at night in a cold area for a long time, moisture in the air in the intake path 8 of each of the throttle bodies T1 and T1 becomes large water drops and freezes around the valve shaft 9a of the throttle valve 9, particularly in a bearing hole in each of the throttle bodies T1 and T2 that supports the valve shaft 9a. Such freezing of the water drops might rigidly fixate the throttle valve 9, making it impossible or very difficult for the electric motor 15 to drive the throttle valve 9 to open and close.

In this respect, according to the present invention, when the engine E is used as a horizontal-type as shown in FIG. 1 in which the crankshaft 1 is in parallel to the horizontal engine installation flange 30, the following effects are obtained. When the engine E is used as a horizontal-type, the first and second throttle bodies T1 and T2 are placed as described above, that is, each of the first and second throttle bodies T1 and T2 is placed in such a manner that the axis A3 of the intake path 8 is substantially perpendicular to the plane P2 including the axis A1 of the crankshaft 1 and the axis A2 of the corresponding bank B1 or B2. This placement allows the intake path 8 of each of the first and second throttle bodies T1 and T2 to incline to the horizontal plane by about 45° and allows the valve shaft 9a of the throttle valve 9, which is orthogonal to the axis A3 of the intake path 8, to incline to the horizontal plane by 45°. Accordingly, most of the condensation water drops generated on the outer periphery surface of the valve shaft 9a flow downward along the valve shaft 9a to the inclined bottom face of the intake path 8, and then flow further downward along the bottom face. The condensation water drops can thus be discharged from the valve shaft 9a. As a result, it can be prevented that large water drops remain on the valve shaft 9a, which in turn prevents fixation of the valve shaft 9a of the throttle valve 9 caused by freezing of the large water drops.

As shown in FIG. 3, when the engine is used as a vertical-type where the crankshaft 1 is perpendicular to the horizontal engine installation flange 30, the intake path 8 of each of the first and second throttle bodies T1 and T2 is substantially horizontal, and also the valve shaft 9a of the throttle valve 9 is substantially horizontal. This allows most of the condensation water drops generated around opposite end parts of the valve shaft 9a in the intake path 8 to flow toward the bottom face of the intake path 8 and to be discharged from the valve shaft 9a. As a result, also in this case, it can be prevented that large water drops remain on the valve shaft 9a, which in turn prevents fixation of the valve shaft 9a of the throttle valve 9 caused by freezing of the large water drops.

In this way, regardless of whether the engine E is used as the horizontal-type or the vertical-type, the throttle valves 9 can be easily prevented from fixation which would be caused by freezing of condensation, without changing the first and second throttle bodies T1 and T2. Consequently, the throttle valves 9 can always be driven to open and close appropriately by the operation of the electric motor 15, allowing the engine E to operate immediately and to start working.

In addition, the first and second throttle bodies T1 and T2 are placed in a valley part between the first and second banks B1 and B2. This valley part allows effective use for the placement of both the first and second throttle bodies T1 and T2 and also allows size reduction of the V-type engine E. Moreover, the length of the intake path from each of the throttle bodies T1 and T2 to each of the corresponding banks B1 and B2 can be reduced to a minimum, which accomplishes improved acceleration responsiveness of the engine E.

Further, the fuel injection valve 10 of each of the first and second throttle bodies T1 and T2 is placed in such a manner that the fuel injection nozzle is positioned obliquely downward with the axis A5 of the fuel injection valve 10 being on the plane P3 including the axis A3 of the corresponding intake path 8 and substantially orthogonal to the axis A2 of the corresponding one of the banks B1 and B2. Accordingly, regardless of whether the engine E is used as a horizontal-type or a vertical-type, each of the fuel injection valves 10 can always maintain its posture in which the fuel injection nozzle faces obliquely downward. Accordingly, after the engine E stops its operation, fuel remaining in the fuel injection nozzle of each of the fuel injection valves 10 slides down promptly. Since the fuel does not keep remaining in the fuel injection nozzles, residual product is prevented from being generated due to deterioration of remaining fuel, and operation failure of the fuel injection valves 10 due to the residual product can be avoided.

Further, since first and second throttle bodies T1 and T2 are compatible with each other, the throttle body of the same structure can be used. This contributes to improvement of the productivity and reduction in costs. Here, the first and second throttle bodies T1 and T2 are placed in such a manner that their respective fuel injection valves 10 are placed to face in a direction toward the same outer surface of the engine E. This allows the fuel injection valves 10 of the two throttle bodies T1 and T2 to be attached/detached or to be inspected and maintained from the same outer surface side of the engine E, thereby yielding easy maintenance.

The present invention is not limited to the above-mentioned embodiment and may be modified in a variety of ways as long as the modifications do not depart from its gist. For example, when the engine E is used as a vertical-type as shown in FIG. 3, the engine installation flange may be formed also to the first case semi-body 2a of the crankcase 2 and to the first and second banks B1 and B2.

1. A general-purpose V-type engine in which
a first bank (B1) and a second bank (B2) are provided continuously to a crankcase (2) supporting a crankshaft (1), the first and second banks (B1, B2) being arranged in a V-shape with its center being a plane (P1) including an axis (A1) of the crankshaft (1), and
an engine installation face (30) is formed on the crankcase (2), the engine installation face (30) being either substantially perpendicular to the plane (P1) and substantially horizontal, or substantially perpendicular to the axis (A1) of the crankshaft (1) and substantially horizontal,
characterized in that
a first throttle body (T1) and a second throttle body (T2) placed between both the banks (B1, B2) are mounted to the first bank (B1) and the second bank (B2), respectively, in such a manner that an axis (A3) of an intake path (8) of each of the first throttle body (T1) and the second throttle body (T2) is substantially perpendicular to a plane (P2) including an axis (A2) of a corresponding one of the banks (B1, B2) and the axis (A1) of the crankshaft (1),
each of the throttle bodies (T1, T2) has a butterfly-type throttle valve (9) pivotally supported therein and a fuel injection valve (10) attached thereto, the butterfly-type throttle valve (9) opening and closing the corresponding intake path (8), the fuel injection valve (10) injecting fuel to the intake path (8) at a portion downstream of the throttle valve (9), and
the throttle valve (9) of each of the first and second throttle bodies (T1, T2) is placed in such a manner that an axis (A4) of a valve shaft (9a) of the throttle valve (9) is substantially orthogonal to the axis (A3) of the corresponding intake path (8) and is substantially parallel to the axis (A2) of a corresponding one of the banks (B1, B2).

2. The general-purpose V-type engine according to claim 1, wherein
the first and second throttle bodies (T1, T2) are compatible with each other, and
the fuel injection valve (10) of the first throttle body (T1) and the fuel injection valve (10) of the second throttle body (T2) are placed to face in a direction toward a same outer surface of the engine (E).

3. A general-purpose V-type engine in which
a first bank (B1) and a second bank (B2) are provided continuously to a crankcase (2) supporting a crankshaft (1), the first and second banks (B1, B2) being arranged in a V-shape with its center being a vertical plane (P1) including an axis (A1) of the crankshaft (1), and
an engine installation face (30) is formed on the crankcase (2), the engine installation face (30) being either substantially perpendicular to the vertical plane (P1) and substantially horizontal, or substantially perpendicular to the axis (A1) of the crankshaft (1) and substantially horizontal,
characterized in that
a first throttle body (T1) and a second throttle body (T2) placed between both the banks (B1, B2) are mounted to the first bank (B1) and the second bank (B2), respectively, in such a manner that an axis (A3) of an intake path (8) of each of the first throttle body (T1) and the second throttle body (T2) is substantially perpendicular to a plane (P2) including an axis (A2) of a corresponding one of the banks (B1, B2) and the axis (A1) of the crankshaft (1),
each of the throttle bodies (T1, T2) has a throttle valve (9) provided therein and a fuel injection valve (10) attached thereto, the throttle valve (9) opening and closing the corresponding intake path (8), the fuel injection valve (10) injecting fuel toward the intake path (8) at a portion downstream of the throttle valve (9), and
each the fuel injection valve (10) is placed in such a manner that a fuel injection nozzle of the fuel injection valve (10) faces obliquely downward with an axis (A5) of the fuel injection valve (10) being on a plane (P3) which includes the axis (A3) of the corresponding intake path (8) and is substantially orthogonal to the axis (A2) of a corresponding one of the banks (B1, B2).

4. The general-purpose V-type engine according to claim 3, wherein
the first and second throttle bodies (T1, T2) are compatible with each other, and
the fuel injection valve (10) of the first throttle body (T1) and the fuel injection valve (10) of the second throttle body (T2) are placed to face in a direction toward a same outer surface of the engine (E).
